(19) United States
(12) Patent Application Publication
(10) Pub. No.: US 2010/0187941 A1
(43) Pub. Date: Jul. 29, 2010

(54) 18/8 SYNCHRONOUS MOTOR

(75) Inventors: Karl-Juergen Roth, Schwieberdingen (DE); Kurt Reutlinger, Stuttgart (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 12/525,004

(22) PCT Filed: Jan. 25, 2008
(86) PCT No.: PCT/EP2008/050852

§ 371 Date: Mar. 17, 2010

(30) Foreign Application Priority Data
Jan. 30, 2007 (DE) 10 2007 004 561.3

(51) Int. Cl. H02K 3/28

(52) U.S. Cl. 310/203

(57) ABSTRACT

The invention relates to a synchronous motor (3) comprising a stator (3) with 18 stator teeth (2). The stator comprises stator coils (7) surrounding the stator teeth (2). The rotor (5) has eight pole magnets (6), each stator coil (7) surrounding at least two stator teeth (2).

The invention relates to an 18/8 synchronous motor with eight rotor poles and eighteen stator teeth, in particular for the use at power assisted steering.

It is necessary at electrical drives for steering systems with electro-mechanical support for the use in motor vehicles, that the range of variation of the driving torque that is created at the shaft is very low. Usually permanently excited commutated synchronous motors are used as such drives, because they are preferred for this application due to their power density, their level of efficiency and their control possibilities. But at electronically commutated synchronous motors so-called harmonic wave moments occur due harmonic waves, which can cause strong variations of the torque. Therefore drives like that have to be configured in a way that those harmonic waves are reduced as much as possible or are low in their effect upon the torque band. Furthermore torque variations occur at such synchronous motors not only under load but also at dead stator winding, which is called cogging torque.

A common method to reduce cogging torques is to choose the relation of a number of stator grooves towards the pole number, that the least common multiple gets as high as possible. This is for example achieved at a synchronous motor with nine stator teeth in the stator and eight rotor poles. This results thereby in seventy-two hold positions per rotation with a low cogging torque amplitude.

But such a synchronous motor reacts very sensitive to variations of the symmetry, which means already slight variations cause significant cogging torques and torque variations.

Furthermore significant radial force waves occur during the operation, which can cause increased noises. Due to manufacturing tolerances an absolute structural symmetry cannot be achieved and a reduction of the tolerances would significantly increase the expenses of the production.

It is the task of the present invention to provide a synchronous motor, which has a lower sensitivity towards variations of the symmetry while keeping the low cogging torques and torque waves and at which the radial force waves are significantly reduced.

This task is solved by the synchronous motor according to claim 1.

Further advantageous embodiments of the invention are provided in the dependant claims.

According to one aspect a synchronous motor is provided with a stator with eighteen stator teeth, which are surrounded by stator coils. Eight pole magnets are arranged at the rotor. Each of the stator coils surrounds at least two stator teeth.

The 18/8 configuration of the synchronous motor of the present invention connect the advantages of a 9/8 configuration of a permanently excited synchronous motor with a higher insensitivity towards structural variations of the symmetry with a significant reduction of the radial force waves. This is realized by doubling the number of the stator teeth regarding the 9/9 configuration and by putting each of the stator coils around at least two of the stator teeth.

Preferably each stator tooth of the synchronous motor is surrounded by two stator coils, which each furthermore surround the two stator teeth that are adjacent to the corresponding stator tooth. The stator teeth, which surround a stator tooth, can in particular provide a reversed winding strand. That causes that the rate of the radial forces, which are caused by stator coils around one of the stator teeth, neutralize each other at least partially. Thereby the radial force waves that occur during the operation of the synchronous motor can be reduced.

Furthermore three stator coils, which surround three stator tooth pairs that are adjacent to each other, are interconnected in series as triad and can be controlled by control connections with a common phase.

Preferably triads that are each shifted to each other by 120° can be controlled by three phase connections and be interconnected in a partial star connection.

According to a further embodiment the partial star connections are either connected with two inverters or with a mutual inverter.

It can be provided that triads that are shifted to each other by 120° at the stator can be controlled by three phase connections and each is connected in a partial delta connection.

According to a further embodiment the stator coils of a first subsystem of eight stator teeth and the stator coils of a second subsystem of eight further stator teeth, which are opposing the eight stator teeth, are not arranged overlapping each other, whereby the stator coils of the first and the second subsystem comprise stator coils, which surround three stator teeth.

The stator coils of one of the subsystems can in particular be arranged in a triad of three stator coils that are in row at stator tooth pairs that are adjacent to each other and in dyads of a stator coils with a simple number of windings around three stator teeth and a stator coil with a double number of windings around two stator teeth, which are in a row.

Furthermore the triads and the two dyads of stator coils of each of the sub system can be interconnected in separated partial star connections or partial delta connections and each can be controlled in three phases by a mutual inverter or inverters that are separated from each other.

Preferred embodiments of the present invention are subsequently explained by the attached drawings. It is shown in:

### DRAWINGS

FIG. 1 a cross-sectional illustration of a 18/8 synchronous motor according to one embodiment of the invention;

FIG. 2 an illustration of the stator coils with regard to the different phases in a clear illustration;

FIG. 3 an illustration of six coil groups, which are interconnected according to arrangements following the figures;

FIGS. 4 to 7 different interconnections of stator coils of the synchronous motors according to the invention;

FIG. 8 a possible configuration of the synchronous motor according to FIGS. 4 to 7, at which two coil arrangements are arranged separated from each other on two sides of the synchronous motor.

### EMBODIMENTS OF THE INVENTION

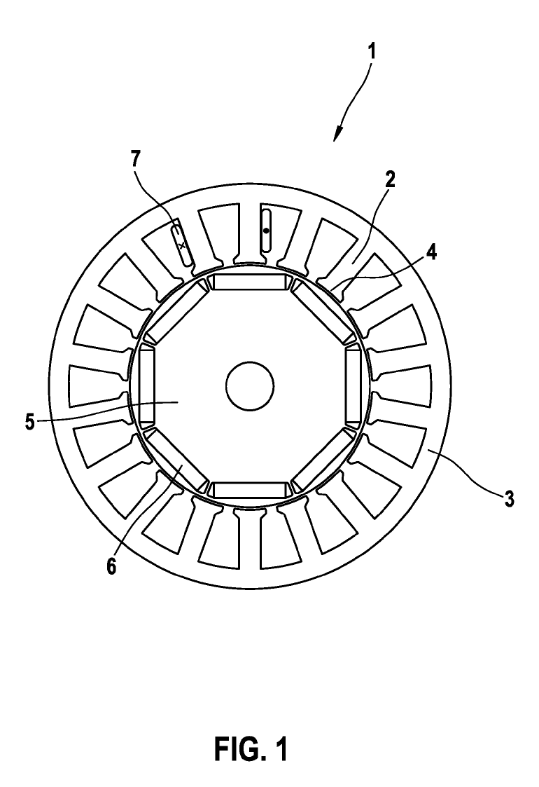

FIG. 1 shows a cross section of a synchronous motor 1 according to an embodiment of the invention. The synchronous motor 1 is build with eighteen stator teeth and poles, and is subsequently called as 18/8 synchronous motor. The stator teeth 2 are arranged at a stator 3, so that each of their tooth tip 4 points towards a mutual center point, whereby each of their central axis runs in radial direction around a center point that surrounds the preferably circular stator 2. Furthermore the stator teeth 2 are arranged evenly, which means with the same distance (drift angle) from each other on the inside of the stator 2.

On the inside of the stator 2 there is furthermore a rotor 5, whose rotation axis corresponds with the center point. The rotor 5 provides eight pole magnets 6 (permanent magnets), which are arranged evenly distributed around the perimeter. Pole magnets 6 that are adjacent to each other provide a polarity that is opposed to each other, so that two pole magnets 6 that are aligned are opposing each other regarding the rotor axis.

The pole magnets 6 in the rotor can be construed as surface magnets as well as buried magnets, which are embedded in the surface of the rotor 5. The use of magnets that are buried in the rotor is advantageous because simple and inexpensive magnet forms, as for example with even surfaces, can be used, and allows a simple rotor construction without bandage and corrosion protection.

The stator teeth 2 are surrounded by stator coils 7, which each surround two stator teeth. For clarity reasons FIG. 1 only shows one stator coil 7. Eighteen stator coils 7 are provided, whereby the stator coils 7 of the stator 3 that are adjacent and surround two stator teeth 2 are arranged around a stator tooth 2 in a shifted way. In order to reduce or eliminate radial force waves of a first order three stator coils of a strand are again shifted by 180° around the rotor or provided mirror-inverted. Cogging torques that occur at such motors are thereby simultaneously not significantly increased as opposed to those of the 9/8 synchronous motor.

Because such a synchronous motor has a mirror-inverted construction as opposed to a 9/8 synchronous motor and the number of grooves, which results from the distances between two adjacent stator teeth, is twice as high, the whole arrangement is less sensitive to symmetry variations due to manufacturing tolerances. Because of this low sensitivity towards tolerances it is possible to accommodate the magnets also in pockets in the rotor. That allows a simple rotor construction and the use of inexpensive block magnets.

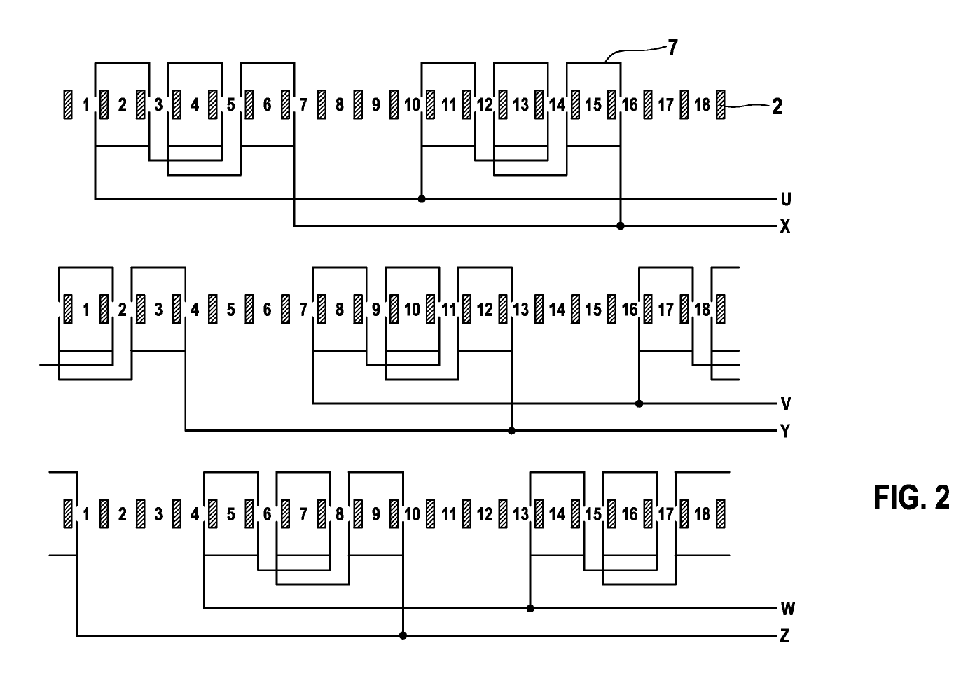

FIG. 2 shows a more clear illustration of the stator coils 7 around the eighteen stator teeth 2. The stator teeth 2 are shown coiled in a row next to each other. For a better clarity the stator coils 7 that belong to different phases are shown separated from and below each other.

In FIG. 2 one can see that each phase controls six stator coils around two stator tooth pairs that are opposing each other with regard to the rotor 5, so that two opposing triads of three stator coils 7 are controlled with one phase. The middle stator coil 7 of each triad of stator coils 7 is controlled with a polarity (direction) that is reversed with regard to the outer stator coils 7.

Those stator coils groups that belong to the three phases can be connected now with each other in a star connection or in a deltas connection. The connections X, Y and Z of a star connection are connected with each other and the three phase voltages are correspondingly applied at the connections U, V and W. analogously the connections X and V, Y and W, as well as Z and U of a delta connection are connected with each other and the so created knots represent the corresponding connections for the phase voltages of the synchronous motor.

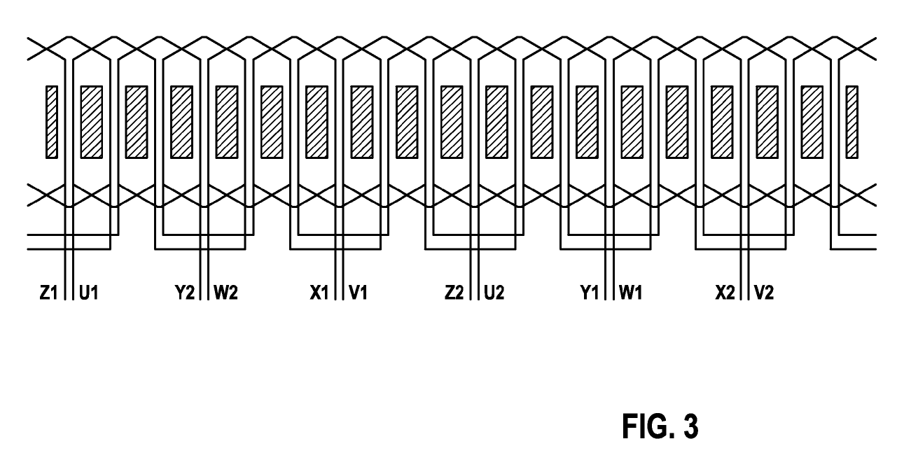

Further possibilities of the connections of stator coils are described below, at which each of the triads of stator coils that are shown in FIG. 2 is considered separately. For the following explanation of different connection types the terms of the different connections U1, V1, W1, X1, Y1, Z1, U2, V2, W2, X2, Y2, Z2 are defined in FIG. 3.

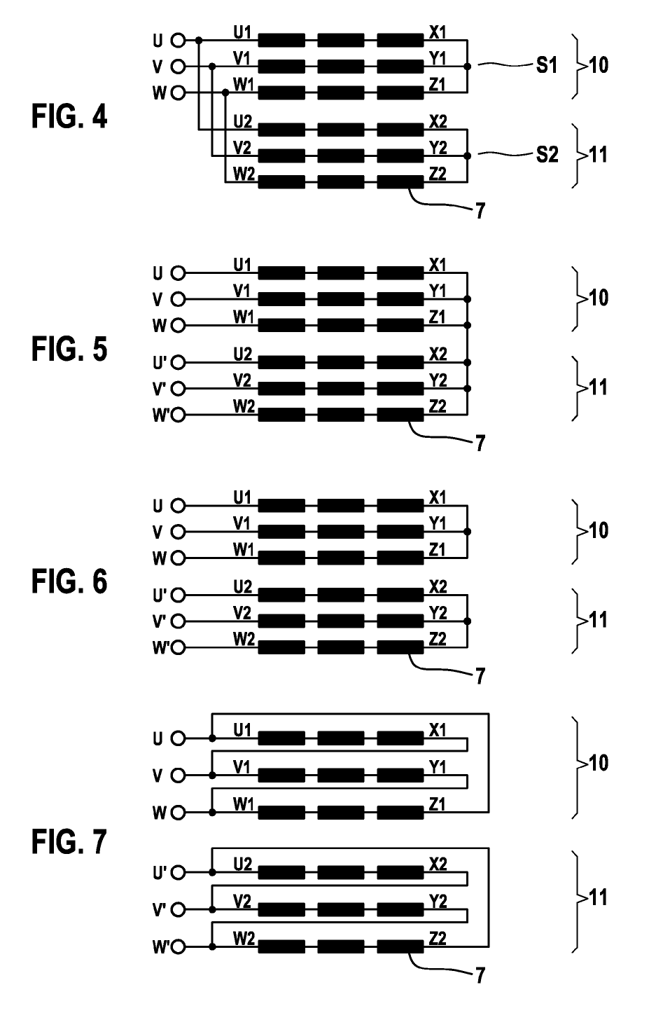

Based on the arrangement of stator coils that are provided in FIG. 3 the stator coils groups can be connected with each other in a star connection with two partial star points S1, S2 as it is shown in FIG. 4. Thereby principally three triads of stator coils 7 that are shifted to each other by 120° are connected as a first subsystem 10 with different phases in a star connection with a first partial star point S1 and the triads of stator coils 7 that are also shifted to each other by 120° are connected with each other by a mutual second partial star point S2 as a second subsystem 11. The subsystems 10, 11 are shifted to each other around the rotor by 180° or arranged mirror-inverted to the rotor. The controlling takes place by three mutual phase voltages U, V, W at corresponding phase connections, whereby two triads of stator coils 7 that are opposing each other are controlled with the same phase voltage.

In the embodiment of FIG. 5 all triads are connected with each other at a mutual star point, but are only controlled by two inverters (not shown) that separated from each other with the three corresponding phase voltages U, V, W or U′, V′, W′. The arrangement corresponds basically with the same one of FIG. 4, so that three adjacent triads of stator coils with three phase voltage U, V, W, which are provided by a first inverter at the corresponding phase connections, are controlled and the three triads of stator coils that are opposed to that are controlled by the corresponding three phase voltages U′, V′, W′ of a second inverter.

FIG. 6 provides an improvement of the embodiment of FIG. 5, which distinguishes itself thereby that the mutual star point is divided, and two subsystems 10, 11 are provided with two partial star points S1, S2, so that an inverter of each of the subsystem 10, 11 controls.

The embodiment of FIG. 7 shows principally an illustration that is equivalent to the embodiment of FIG. 6, whereby the circuits of the three triads of stator coils 7 that are independent of each other are not connected as partial star connections, but as partial delta connections. Two subsystems 10, 11 that are completely separated from each other are also created in FIG. 7, which are opposing each other at the stator 3 of the synchronous motor 1.

In order to further enable that shorts are mostly avoided between the individual systems that are electrically separated from each other, the stator coils 7 of the triads that belong to one of the subsystem 10, 11 are structurally completely separated from each other. In the previously described embodiments the stator coils 7 of both subsystems surround mutual stator teeth 2, and therefore connections between the two subsystems may occur in the case of shorts, so that an increased braking torque can be caused.

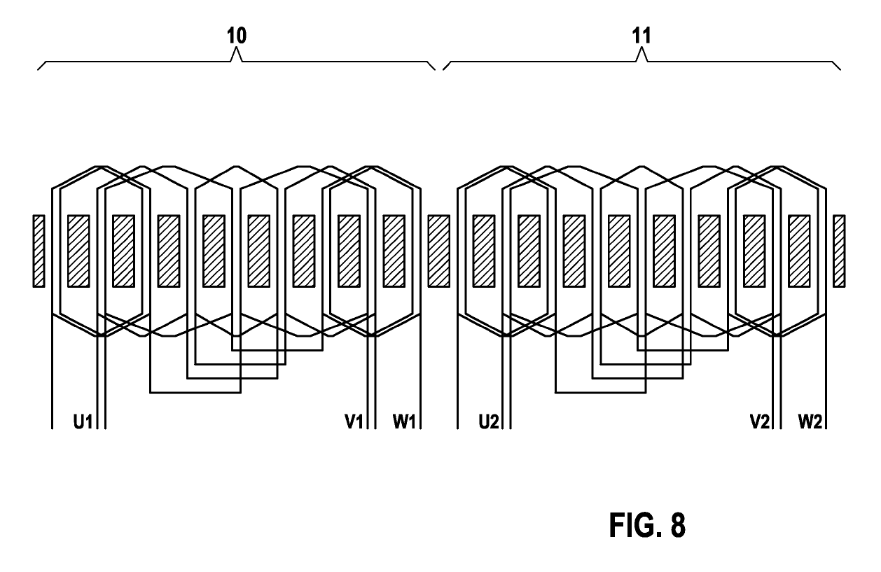

As it can be seen from FIG. 8 it is possible to provide start coils 7 in such a way that the subsystems 10, 11 with the corresponding stator coils 7 that are shown in FIGS. 4, 5, 6 and 7 are completely separated from each other, so that none of the stator coils 7 of one of the subsystems 10, 11 surrounds the same stator tooth 2 like a stator coils 7 of the other subsystem 10, 11. This is achieved thereby that the two subsystems are each spatially arranged on one side of the synchronous motor. This is achieved thereby that stator coils 7, which surround the three stator teeth 2, and stator coils with a varied number of turns per unit length are provided.

Each subsystem that is arranged on one side of the synchronous motor provides three stator coil groups at eight adjacent stator teeth 2. The structure of the middle one the three stator coil groups corresponds thereby with a triad according to the previously shown embodiments and is arranged at the six middle stator teeth 2 of the eight stator teeth 2 that are arranged next to each other. The two stator coil groups that are arranged on the outside regarding the eight stator teeth 2 that are arranged next to each other, provide only two stator coils 7. One of the two stator coils provides the double number of windings as the stator coils of the triad and surrounds two stator teeth 2. The corresponding other stator coil 7 provides a simple number of windings and surrounds three stator teeth 2. The two stator coils 7, which surround the three stator teeth 2, are not arranged overlapping each other at the stator teeth 2 of the middle triad. By this means it is achieved that the same number of winding wires is located in each groove between the stator teeth 2.

According to a further embodiment the 18/8 synchronous motor can also be implemented as 9-phase machine, in which each of the eighteen stator coils is connected separately. In that case stator coils that are opposing each other can be operated in one phase.

A synchronous motor according to the above suggested embodiments has a significantly reduced cogging torque and produces lower radial force waves during operation. For this reason such synchronous motors qualify for the use in steering systems for motor vehicles.

1. A synchronous motor with a stator with eighteen stator teeth, whereby stator coils are provided, which surround the stator teeth, and whereby eight pole magnets are arranged at the rotor, in that each of the stator coils surrounds at least two stator teeth.

2. The synchronous motor according to claims 1 wherein each of the stator teeth are surrounded by at least two stator coils, which each furthermore surround the stator teeth that are adjacent to both sides of the corresponding stator tooth.

3. The synchronous motor according to claim 1 wherein three stator coils, which surround three stator teeth pairs that are adjacent to each other, are interconnected in row to a triad and can be controlled by a common phase.

4. The synchronous motor according to claim 3 wherein triads that are displaced to each other by 120° can be controlled by three phase connections and are interconnected in a partial star connection.

5. The synchronous motor according to claim 4 wherein the partial star connections are either connected with two inverters or with one mutual inverter.

6. The synchronous motor according to claim 3, wherein groups of three that are each shifted to each other by 120° can be controlled by three phase connections and are connected in a partial delta connection.

7. The synchronous motor according to claim 6 wherein the partial delta connections are either connected with two inverters or with one mutual inverter.

8. The synchronous motor according to claim 1 wherein the stator coils of a first subsystem are arranged completely separated from eight stator teeth and the stator coils of a second subsystem from eight further stator teeth opposing those stator teeth, whereby the stator coils of the first and the second subsystem comprise at least one stator coils that surrounds three stator teeth.

9. The synchronous motor according to claim 8 wherein the stator coils of one of the subsystems are arranged in a triad of three stator coils that are in row to stator teeth pairs that are adjacent to each other and in two dyads of a stator coils with a single number of turns per unit length around three stator teeth and a stator coil with a double number of turns per unit length around to stator teeth, which are in a row.

10. The synchronous motor according to claim 9 wherein the triad and the two dyads of stator coils of each of the subsystems in separated partial star connections or partial delta connections are interconnected with each other and can be controlled three-phased by a mutual inverter or inverters that are separated from each other.

11. The synchronous motor according to claim 1, wherein the pole magnets are embedded in pockets that are arranged at the rotor.

12. The process of using a synchronous motor according to claim 1 in a steering system of a motor vehicle.
